(19) United States
(12) Patent Application Publication
(10) Pub. No.: US 2012/0236550 A1
(43) Pub. Date: Sep. 20, 2012

(54) Remote controlled beacon light/flashlight AKA: the tree beacon

(76) Inventor: Mickey McArthur Kennedy, Medina, OH (US)

(21) Appl. No.: 13/065,214

(22) Filed: Mar. 17, 2011

(51) Int. Cl. F21L 4/02

(52) U.S. Cl. 362/184

(57) ABSTRACT

The disclosed subject matter relates to an apparatus that when properly used can aid and assist in location of a preferred spot to be returned to at a later time or day. This device can be left hanging in a tree, from an elevated stand or any location desirable to the owner. Upon returning to said location a FOB remote unit can turn on the Tree Beacon from 300 meters. Just follow the flashing light.

### TECHNICAL FIELD

The present application relates to a remote controlled device and more particularly to a remote controlled beacon type light with secondary flashlight.

### BACKGROUND

Due to growing demand of navigating thru unknown terrain and finding the preferred location again in total darkness, most of all by hunters of wild game, a device for finding this spot is needed.

There are a number of devices on the market for navigation. The GPS being most popular and now the telephone.

Thus a device for locating the spot where one wants to return is and will be described and referred to as THE TREE BEACON.

### BRIEF DESCRIPTION OF DRAWINGS

FIG. 1A is an example of the typical shape and configurations of the Beacon Light and its outward appearance. This depiction is not to any scale.

FIG. 1B is a cross section of said article of description and shows the components making up the entire unit.

FIG. 2A is a cross section of the lens showing the detailed layout of the removable lens with LEDS and waterproof cover.

FIG. 2B is a section view of the location of the LEDS in relationship to the circular shape of light.

FIG. 2C is a frontal view of the lens cover with hole in middle emitting light rays from LEDS.

FIG. 3A is a sketch of a FOB or sending unit with regards to the location of buttons and light.

FIG. 3B is a cross section of the sending unit and showing integral parts of said unit.

### DETAILED DESCRIPTION

The disclosed subject matter is now described with reference to the drawings with details to function.

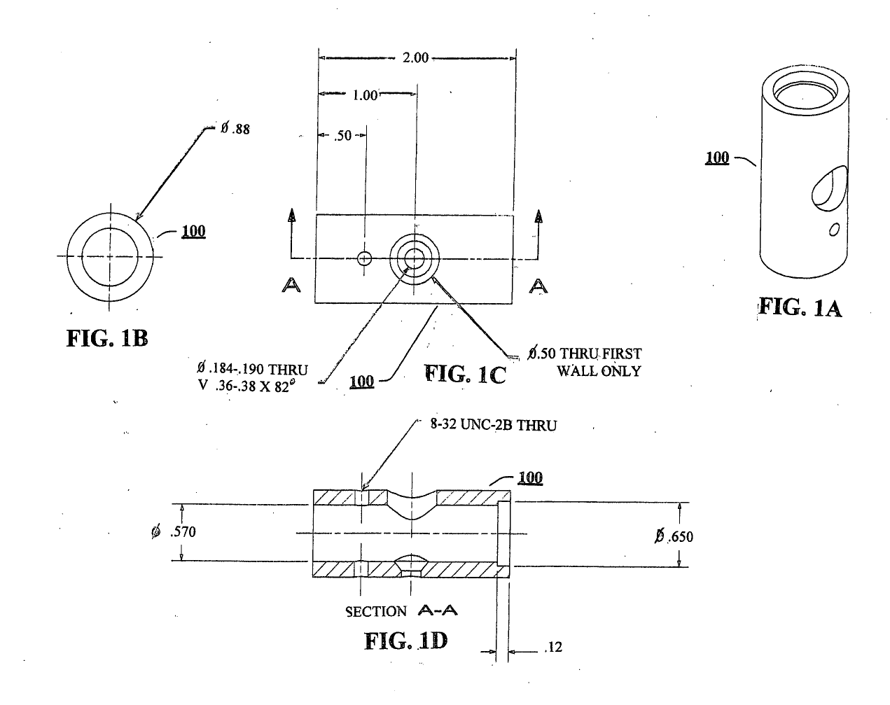

FIG. 1B being the main body of said object containing the receiving unit with electronics capable of receiving signal from POD and energizing the beacon light.

FIG. 1B Contained therein is also the battery pack supplying mini volt current for electronics and lighting of the LEDS.

FIG. 1B contained therein are the LEDS and will emit a beacon type light pulsating every 1 second. Not limited to this single frequency and may be used with various frequencies.

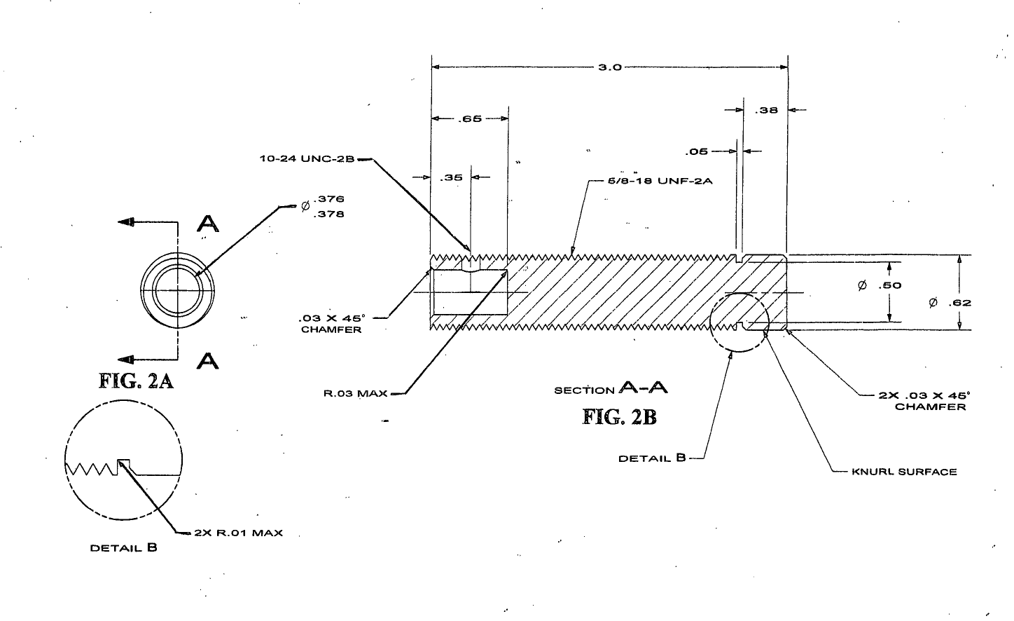

FIG. 2A therein is a depiction of the assembled parts of the LEDS and the removable lens head wherein different color lenses may be used. Also included in this design is a removable reflector for transferring light rays at various angles depending on degree of angle of reflector.

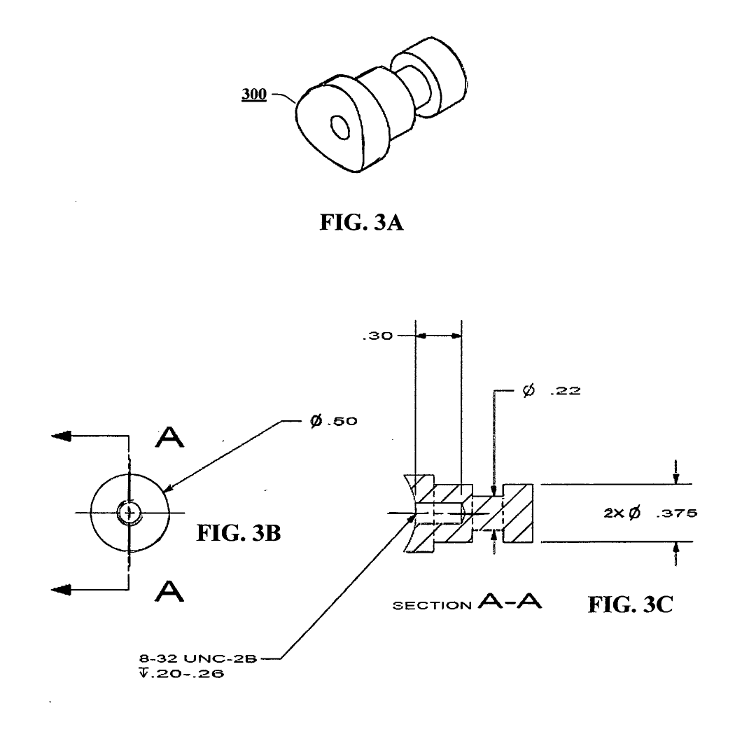

FIG. 3A is drawing of FOB and therein will be an on and off button for remotely sending signal to beacon light for visual contact with desired point of rendezvous.

FIG. 3B therein contained is the remote transmitter showing the electronics and battery power source.

In particular and in regard to the various uses of said device. The intent of this device (TREE BEACON) is for the visual location of a preferred site marked by the location of the tree beacon left there from previous visit.

This device is not limited to the flashlight shape only. Can be of many shapes and sizes and located in remote areas. Capable of functioning in any terrain and surroundings.

What is claimed:

1) An apparatus for finding a location in the dark, A flashlight shaped device with capabilities of being a flashlight and a beacon.

2) The apparatus in claim 1, wherein there is a remote receiver to receive signal from FOB hand held unit to turn on beacon light.

3) The apparatus in claim 1, wherein there is contained the power source (batteries) supplying the energy to receive signal and supply power source to light the LEDS.

4) The apparatus in claim 1, wherein there is contained the LEDS for use as a flashlight or beacon.

5) The apparatus in claim 1, wherein there is center LEDS used for the flashlight only and activated with the attached on/off button.

6) The apparatus in claim 1, wherein there is the outer LEDS used in conjunction with the remote and activated for use as the beacon

7) The apparatus in claim 1, wherein there is located the lens cover for gathering light for the beacon effect and a circular hole for the directing of light when used as a flashlight.

8) The apparatus in claim 1, wherein there is an antenna as an integral part intended for receiving the signal from a hand held FOB.

9) The apparatus in claim 1, wherein there is an associated FOB for transmitting the signal from a remote location therefore turning on beacon.

10) No matter what the need the apparatus described in claim 1 can return you to a desired location from long distances.
